(19) United States
(12) Patent Application Publication
(10) Pub. No.: US 2007/0153812 A1
(43) Pub. Date: Jul. 5, 2007

(54) Dynamic discovery of a network service on a mobile device

(76) Inventor: John Kemp, Williamstown, MA (US)

Correspondence Address: Hollingsworth & Funk, LLC, Suite 125, 8009 34th Avenue South, Minneapolis, MN, 55425, US

(21) Appl. No.: 11/321,751

(22) Filed: Dec. 29, 2005

(51) Int. Cl. H04Q 7/00; H04L 12/56; H04L 12/28

(52) U.S. Cl. 370/401; 370/328

(57) ABSTRACT

A network service is made available on a device capable of operating on a first network that is coupled to a second network via a Network Address Translator (NAT). One or more User Datagram Protocol (UDP) messages with an entity of the second network. Based on the exchange of UDP messages, an IP address and port used by the NAT on the second network is determined for purposes of accessing the device on the first network via the second network. The IP address and port are registered with a discovery service of the second network. Network services are requested from the device via the second network using the IP address and port obtained via the discovery service. In one arrangement, the exchange of UDP messages involves the use of Simple Traversal of UDP Through NATs (STUN) messages.

### FIELD OF THE INVENTION

This invention relates in general to computer networking, and more particularly to allowing access to services on devices located behind network address translators.

### BACKGROUND OF THE INVENTION

Mobile communications devices such as cell phones are gaining wide acceptance. The popularity of these devices is due their portability as well as the advanced features being added to such devices. Modem cell phones and related devices offer an ever-growing list of digital capabilities. For example, many phones may be equipped with server software that allows the devices to provide particular network services.

In the client-server model of computing, a server is usually a computer that listens for incoming network connections, and a client is a device that initiates those connections. In some applications, such as network file systems or peer-to-peer file sharing, devices may act as both client and server in the same transaction. In order for a server to provide a network service on a Transmission Control Protocol/Internet Protocol (TCP/IP) network, a server process listens on a predetermined TCP port. Some TCP ports are commonly associated with specific services, such as port 23 with telnet and port 80 with the Hypertext Transport Protocol (HTTP).

One problem in using mobile devices as TCP/IP servers is that, depending on their location, mobile devices may not be IP addressable. Such devices are typically located on a network that lies behind a Network Address Translator (NAT) maintained by the mobile operator or other network provider. A NAT may not always assign an externally accessible IP address to the device until the device makes an outgoing connection request. The firewall then dynamically assigns a short-lived external IP address. The firewall also typically prevents incoming TCP connection requests on this address by blocking the SYN packets required to initiate the TCP connection establishment handshake.

Use of NATs is common in enterprise environments, and also within mobile phone network environments, where a Mobile Network Operator (MNO) will assign addresses to mobile devices that are not publicly available. Often, the device may not even know its own address on the internal network, and will not be able to provide a public network address that may be used by some other entity that wishes to communicate data with such a device. This, of course, makes it difficult to access the device's services from outside of the network on which the device is present.

Many common mobile applications, such as browsing and email, can operate as a pure client, thus the inability to offer services from behind a NAT is not problematic to the use of these applications. However, one useful mobile application, service discovery, may involve the provision of a network service from mobile devices. Service discovery generally involves a mobile device providing details of services available from that device. For example, a user calendar may be maintained locally at the user device and published as a service so that trusted network entities access the calendar. Such services are an integral portion of an overall scheme of “network identity,” which allows a user to have a unique online presence that spans different devices and networks. Mobile devices are an important part of such network identity, because these devices are the most likely to be readily available at any given time and place. However, if mobile devices are unable to provide functions such as service discovery in common network environments, then it will be much more difficult to implement a truly useful network identity framework. Given the advantages provided by NATs and restricted mobile environments, it is unrealistic to expect these restrictions to go away, or even that the restrictions will be uniformly applied from network to network. Therefore, it is desirable to provide IP services from mobile devices that run behind NATs or in networks that restrict the ability of the device to determine an externally accessible IP address from which to provide services.

### SUMMARY OF THE INVENTION

To overcome limitations in the prior art described above, and to overcome other limitations that will become apparent upon reading and understanding the present specification, the present invention discloses a system, apparatus and method for providing publicly accessible services from a mobile device located behind a network address translator.

In accordance with one embodiment of the invention, a method for discovering a network service on a device capable of operating on a first network that is coupled to a second network via a Network Address Translator (NAT) includes exchanging one or more User Datagram Protocol (UDP) messages with an entity of the second network. Based on the exchange of UDP messages, an IP address and port used by the NAT on the second network is determined for purposes of accessing the device on the first network via the second network. The IP address and port are registered with a discovery service of the second network. Network services are requested from the device via the second network using the IP address and port obtained via the discovery service.

In a more particular embodiment of the invention, exchanging the one or more UDP messages with the entity of the second network involves exchanging Simple Traversal of UDP Through NATs (STUN) messages with a STUN server of the second network. Registering the IP address and port with the discovery service may involve registering using a Reverse Hypertext Transport Protocol Binding for SOAP (PAOS) procedure call and/or using a Liberty Foundation Web Services Framework (ID-WSF) discovery Modify message. Requesting network services may involve asynchronously sending a UDP datagram to the IP address and port to the device via the second network, and may also involve providing the network service from the device in response to the UDP datagram. Providing the network service may involve providing the service via Reverse Hypertext Transport Protocol Binding for SOAP (PAOS) and/or via an exchange of additional UDP datagrams. Registering the IP address and port with the discovery service of the second network registering may involve communicating to the discovery service a reference to one or more ID-WSF resource offerings of the device.

In another embodiment of the invention, a data processing arrangement includes a network interface capable of communicating via a local network using a local address. A processor is coupled to the network interface, and a memory is coupled to the processor. The memory includes instructions that cause the processor to initiate a User Datagram Protocol (UDP) message exchange with a server of a public network. Based on the UDP message exchange, the processor determines an address and port of the public network usable to access the data processing arrangement on the local network via the public network. The processor registers the IP address and port with a discovery service of the public network, and receives network service requests from entities of the public network that obtained the IP address and port via the discovery service.

In another embodiment of the invention, a system includes a first and second network coupled via a Network Address Translator (NAT). A data processing device is capable of operating on the first network. The system includes means for determining an IP address and port used by the NAT on the second network for purposes of accessing the device on the first network via the second network, means for registering the IP address and port with a discovery service of the second network, and means for requesting network services from the device via the second network.

In another embodiment of the invention, a server includes a network interface capable of communicating via a public network. A processor is coupled to the network interface, and a memory is coupled to the processor. The memory includes instructions that cause the processor to exchange via the network interface Simple Traversal of User Datagram Protocol Through Network Address Translators (STUN) messages with a mobile device coupled to the public network via a Network Address Translator (NAT). The STUN message exchange is used to determine an address and port of the NAT usable for accessing the mobile device via the public network. The processor receives via the network interface a registration request associating the IP address and port with a network service of the mobile device, and provides a descriptor of the network service containing the IP address and port in response to a service query received via the public network. The service query may include a Liberty Foundation Web Services Framework (ID-WSF) Discovery Query.

In another embodiment of the invention, a processor readable medium has instructions which are executable by a data processing arrangement capable of being coupled to a local network. The instructions cause the arrangement to perform steps including exchanging one or more User Datagram Protocol (UDP) messages with an entity of a public network via the local network, the public network coupled to the local network via a Network Address Translator (NAT). Based on the exchange of UDP messages, the arrangement determines an IP address and port of the public network used by the NAT for purposes of accessing the data processing arrangement on the local network via the public network. The arrangement registers the IP address and port with a discovery service of the public network, and receives network service requests via the IP address and port of the public network that were obtained via the discovery service.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1 is a block diagram illustrating a system according to an embodiment of the invention;

FIG. 2 is a sequence diagram illustrating a discovery exchange according to an embodiment of the invention;

FIG. 3 is a sequence diagram illustrating an alternate discovery exchange according to an embodiment of the invention;

FIG. 4 is a block diagram illustrating a client device according to an embodiment of the invention;

FIG. 5 is a block diagram illustrating a network infrastructure element according to an embodiment of the invention; and

FIG. 6 is a flowchart illustrating a procedure for discovering network service according to an embodiment of the invention.

### DETAILED DESCRIPTION OF EMBODIMENTS OF THE INVENTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Generally, the present invention relates to network services provided from devices that traditionally are used as network clients. These client devices typically include desktop/portable computers and wireless devices such as PDAs and cell phones. However the present invention may be applicable to any processing device, including game consoles, desktop boxes, “smart” appliances, automotive electronics, etc. The term “network services” generally refer to the device's ability to provide a data processing operation on demand in response to a request originating elsewhere on the network. The requests and associated responses may be asynchronous or synchronous, and generally involve the exchanges of data via the network using one or more predetermined protocols and data formats.

In order to provide a network service, a user device typically requires networking hardware and the software protocols/programs needed to interact as defined by the service's specification. Many modem computer devices have this hardware and software capability, but the network services still cannot be provided if the user device is not accessible by those entities desiring to use the services. In particular, entities such as NATs are typically set up to prevent or restrict public network entities from accessing hosts on an internal, protected network. One reason for this is that NATs are often part of a firewall that is specifically designed to block connection requests. In addition, the primary purpose of a NAT is to allow multiple computers on the internal network to share a single, public, IP address.

Sharing of the public IP address is made possible by the NAT creating a mapping between an internal IP address/port combination and the public IP address combined with a (typically) dynamic or private port. However, a NAT cannot allow multiple computers to act as servers using the same public IP address and port combination, because the NAT can only have one listening socket for any given address/port combination. Thus, even where a NAT does not intentionally block connections (e.g., when configured as a firewall) the NAT cannot allow

The behaviors of NATs in dealing with incoming connection requests may vary depending on the configuration of the network. An incoming TCP connection request can usually only be accepted by a NAT if the NAT has a predetermined internal host set up to receive connections on that port, in which case the connection request is forwarded to that host. Alternatively, the NAT can service the connection itself, such as when providing access for a Web based NAT configuration program. For well known ports (e.g., HTTP TCP port 80), the NAT will typically require that a host (or the NAT itself) be pre-assigned to receive incoming requests at that port, otherwise the request is rejected. For this reason the functionality of the NAT is often combined with that of a firewall. One function of a firewall is to reject some or all connection requests from the public network per the firewall's security and routing policies.

The behavior of the NAT in dealing with incoming requests will preclude most client devices from receiving TCP requests via the NAT. In particular, the NAT typically will not have a predetermined mapping of well known ports to a mobile client on the internal network, because mobile clients are usually transitory on the network. The client devices may disappear and reappear on the network at any time, and the client may be dynamically assigned different IP addresses each time it connects. Therefore, a NAT usually cannot be set up to route incoming TCP connection requests to a transient device. The NAT will, however, maintain a mapping of TCP ports to the transient device for outgoing TCP/IP sockets initiated by the device, but this mapping can only be used by the addresses/ports that define the socket endpoints, and such mapping is destroyed after the socket is closed.

The situation is different when it comes to the NAT's treatment of UDP data. For connectionless protocols such as UDP, the NAT may be required to maintain dynamically mapped external-to-internal address/port pairs for a specific amount of time, because the connectionless nature of UDP means that the NAT cannot rely on ongoing connection to determine when to create or destroy a mapping. Therefore, the NAT should be prepared to accept incoming UDP datagrams for a particular host based on a prior outgoing UDP datagram sent from that host. The NAT will create a dynamic mapping for this purpose, and will usually maintain the mapping for a specific amount of time that is set by the vendor. A network device behind a NAT can use this dynamic mapping for purposes of accepting incoming service requests, and in some NATs, these incoming service requests can originate from external hosts other than that host that received the initial datagram that created the mapping.

The behavior of NATs relative to mapping of incoming UDP ports and addresses has been generally divided into four categories as described in IETF RFC 3489, Simple Traversal of User Datagram Protocol Through NATs (STUN). The four categories are full cone, restricted cone, port restricted cone, and symmetric. With full cone and restricted cone NATs, requests from the same internal IP address and port are mapped to the same external IP address and port. The full cone NAT allows any external host to send packets to the mapped external address/port, whereas the restricted cone will only allow an external host (as identified by the host IP address) that has previously received packets from the mapped address/port to send packets to the same. The port restricted NAT extends the restrictions of the restricted NAT to include port numbers of the external host, so that the NAT will only allow incoming packets coming from an address and port combination that that NAT had previously sent packets to. The symmetric NAT creates a specific mapping from internal address/port and destination address/port. If the internal host sends another packet with the same internal address/port but to a different destination, the NAT creates a new, separate mapping. As with the restricted cone NAT, the symmetric NAT only allows incoming packets to be accepted from external hosts to which a packet was previously sent.

The foregoing description of different types of NATs is presented in IETF RFC 3489, which describes STUN in greater detail. STUN is a protocol that allows network devices to determine whether they are located behind a NAT, and if so, what publicly accessible IP address may have been allocated to the device by the NAT. STUN has been used for such applications as Voice over IP (VoIP) to allow incoming connections to certain network applications that are located on restricted access networks. However, it may be possible to use STUN in other application areas. In particular, STUN may allow developing improved methods of data sharing from remote devices.

One example of this data sharing is in the form of network services provided from a user device. One form of service commonly provided from mobile services includes operations that are generally described as identity services. An identity service is an abstraction used to describe network data exchanges used for purposes such as retrieving information about an identity, updating information about an identity, or performing some action for the benefit of some identity. An identity is generally data associated with a person or other autonomous entity, and may include descriptive data that is associated with a particular user (e.g., names, address, phone number, and calendar data) or device.

One form of identity service is defined as part of the Liberty Federation Web Services Framework (WSF) Discovery Service specification (ID-WSF). The ID-WSF defines an information model and protocols for sharing service descriptions. Generally, ID-WSF 1.1 defines different types of identity services. Each type of ID-WSF identity service has a unique service type that is identified by a URI. For example, a “calendar service” service type could be identified by a URI such as urn:example:services:calendar. The service type URI maps to an abstract Web Service Definition Language (WSDL) definition of a service.

An instantiation of a particular type of identity service is known as a service instance. A service instance maps to a concrete WSDL document that inherits from an abstract WSDL service description. An abstract WSDL service description includes wsdl:binding, wsdl:service, and wsdl:port elements, thus the service instance inherits these elements as well. The service instance contains information necessary for a client to communicate with the particular service instance, such as the protocol endpoint and security policy information. For example, an instantiation of the “calendar service” service type could be a calendar service offered via a SOAP-over-HTTP endpoint.

Another concept related to WSDL service discovery deals with resources. A resource may be data related to an identity and/or services acting for the benefit of some identity. A resource may also be identified by a URI. When a client sends a request message to a service instance, it includes the URI of the resource it wishes the service instance to act upon. In the calendar service example, the resource related to the calendar service instance could be a calendar containing appointments for a particular identity.

It is possible for there to be a many-to-many relationship between resources and service instances. For example, an email service instance and a calendar service instance may both offer one or more calendar resources associated with one or more end users, as both of these services may deal with reading and setting appointments on users' calendars. In another example, a single personal profile service instance could serve up a plurality of profiles, as it may be inefficient or impractical to maintain a separate protocol endpoint for each profile.

Because there are many ways in which services and resources may interrelate, a service instance and a resource are associated by way of a resource offering. The ID-WSF specification defines a ResourceOffering element that performs this association. The ResourceOffering element contains ResourcelD and ServiceInstance elements. The ResourceID element contains a URI of a resource that can be used when accessing the ServiceInstance described in the ResourceOffering.

A requester can discover resource offerings by way of the ID-WSF Discovery Service. The Discovery Service is itself an identity service, one that provides discovery resources in the form of resource offerings. Therefore, a user who wishes to make a collection of services available will place descriptions of these services and associated resources on a discovery service.

Although the present invention is applicable to ID-WSF 1.1 Discovery Services, it will be appreciated that the concepts described herein may be equally applicable to other discovery mechanisms. For example, ID-WSF 2.0 defines what are called endpoint reference (EPR) instead of resource offerings. The ID-WSF EPR is a document (e.g., XML document) that describes service instances available via a user agent on behalf of a principal (e.g., a device that provides network services on behalf of a user). A requestor may request EPRs related to specific service instances, and thereafter interact with such instances with the service instances acting as Web Service Providers (WSP).

Note that the service transactions described above may require that a user agent (or other user device) operate as a service, such as by listening for incoming service requests while acting as a service provider. The service requests are often in the form of Simple Object Access Protocol (SOAP) calls. SOAP is a message based protocol that may be used to perform remote procedure calls over a network. SOAP messages are in the form of extensible Markup Language (XML) documents and may be bound to various underlying protocols, the most common of which is Hyptertext Transport Protocol (HTTP). Generally, the rules for using SOAP messages within or on top of other protocols for purposes of message exchanges are known as a “bindings.”

In order to receive service requests via a SOAP-to-HTTP binding, a device would run an HTTP server in order to receive incoming request messages (e.g., request for an ID-WSF ResourceOffering). However, as described in more detail above, this is problematic when the user agent is operating behind a NAT, because the device may not be publicly addressable, and therefore requests from outside the NAT cannot be routed to the device. Even if the device is publicly addressable in some fashion, the device may have no way of knowing what publicly accessible IP address and port the NAT has assigned to it. Thus, using the standard SOAP to HTTP binding, a service provider may not be able to initiate connections with the user agent located behind a NAT.

In the past, this problem with providing service from devices behind NATs had been solved using a Reverse HTTP Binding for SOAP, also known as PAOS (which is SOAP spelled backwards). In a traditional SOAP to HTTP binding, a SOAP method may be invoked via HTTP by the requestor either initiating an HTTP GET (if the method does not require sending a SOAP request message) or an HTTP POST (if the method requires sending a SOAP request message). In response to either the GET or POST, the requestor receives a response in the form of a SOAP message. In contrast, PAOS involves the service provider (e.g., the one who receives the SOAP request) first sending an HTTP request to the service consumer, which is operating as an HTTP server. The SOAP request message is contained in the HTTP response received from the service consumer. The service provider then initiates a second HTTP transaction with the service consumer, this time including the SOAP response in an HTTP POST. Because the service provider has no problem sending connection requests to publicly addressable hosts outside the NAT, PAOS allows a device behind a NAT to provide a Web service.

The use of PAOS is always synchronous, because it requires the service provider to first initiate an HTTP request to the service consumer before the consumer can use the service. Therefore, the service consumer is limited as to when requests can be made. In the implementation of discovery mechanisms, this means that discovery can only occur when the user agent device so chooses to connect to a discovery service via HTTP. However, there are benefits in allowing a discovery service to initiate discovery requests asynchronously, without requiring the service provider to first initiate a network request. To this end, an enhanced ID-WSF Discovery service may utilize a protocol such as STUN in order to allow asynchronous requests.

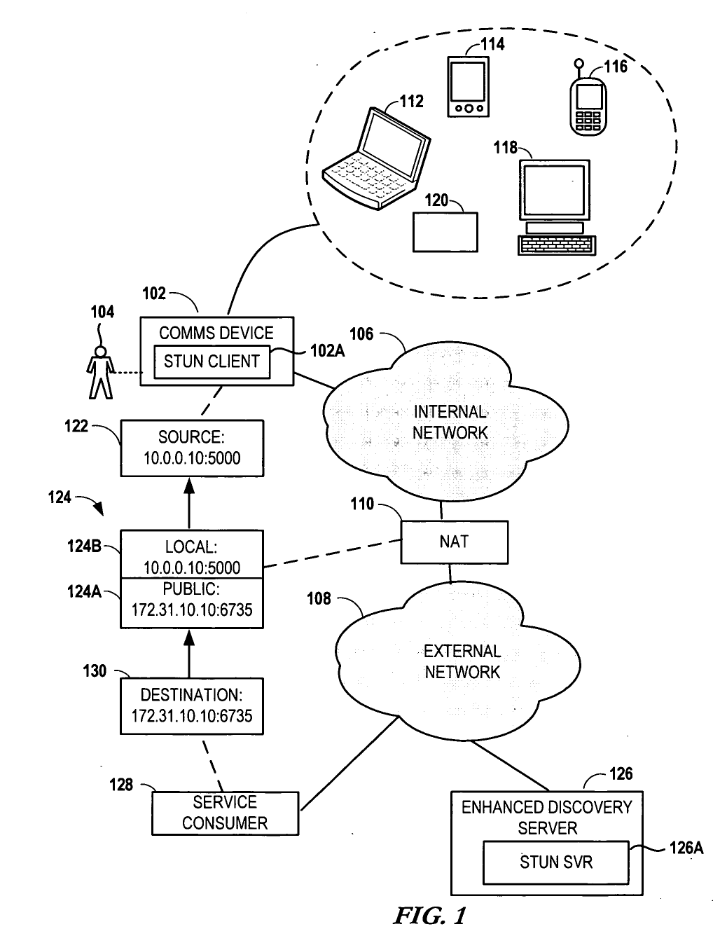

In reference now to FIG. 1, a block diagram illustrates a system according to an embodiment of the invention. The system includes a device 102 belonging to a user 104 that operates on an “internal” network 106. Generally, a device on the internal network 106 accesses an external network 108 via a NAT 110. The NAT 110 may provide a number of functions such as routing and firewalling, and internally maps between internal and external addresses on the respective networks 106, 108 on behalf of devices on the internal network 106. The internal network 106 is typically a Local Area Network that uses NAT for allowing multiple devices on the network 106 to share a single IP address of the external network 108. The external network 108 is typically a wide area network (WAN) or global area network (GAN) such as the Internet. It will be appreciated, however, that the networks 106, 108 may be any configuration and size, and the use of the terms “internal” and “external” to describe the networks 106, 108 is merely for purposes of explanation and not of limitation.

The user device 102 may be any networked device, such as a laptop/portable computer 112, PDA 114, mobile phone 116, desktop computer 118, or other device as represented by generic device 120. The device 102 typically has an IP address that is suitable for exchanging data on the internal network 106. This IP address will be placed in the source field of IP header for outgoing requests, as indicated by example source field 122. For destinations that are outside of the local network (e.g., the external network 108), the device 102 will use a default route that causes the request to be routed to the NAT 110. The NAT 110 will create a mapping 124 between the internal address/port and an external address/port and modify the packet headers with the indicated publicly addressable source address/port 124A.

If, for example, an outgoing request from the device 102 is destined for a server such as the discovery server 126, the NAT 110 will replace the internal IP address/port 124B with the public address/port 124A. Response packets sent from the server 126 to the user device 102 will have this public address/port 124A placed in the destination field of the response packets. The NAT 110 will receive these packets and, using the mapping 124, replace the public address 124A with the internal address 124B such as was in the source field 122 of the outgoing packets. If the original request was part of a TCP/IP connection, the mapping 124 will be good for as long as the connection remains open, and will only be valid for the endpoints of the TCP/IP socket (e.g., device 102 and server 126). However, where the original request packet was a UDP datagram, there is no connection, so the NAT 110 will need to maintain the mapping 124 for some predetermined amount of time to allow the communications session to continue. The amount of time, as well as the behavior of the NAT 110 with respect to incoming UDP datagrams is described more fully in the STUN specification. In many cases, STUN can allow the device 102 to use this UDP mapping 124 by the NAT to accept asynchronous service requests from an entity such as the discovery server 126, even if the server 126 did not receive the initial datagram that created the mapping 124.

In one arrangement, the user device 102 includes a STUN client 102A that discovers the existence of the NAT 110 by sending a UDP datagram to a STUN server. In the illustrated example, the discovery server 126 is enhanced to include a STUN server module 126A, although it will be appreciated that a separate STUN server may also be used. The STUN client 102A may be provisioned with an identifier (e.g., URI, hostname, IP address) used to access the STUN server 126A, or may discover the location of the STUN server 126A through some other discovery mechanism. After the device 102 is established on the internal network 106, the STUN client 102A sends a series of specially crafted UDP datagrams to the STUN server 126A. Based on the response to one or more of these datagrams, the STUN client 102A determines the existence of the NAT 110 and whether the NAT 110 uses a mapping 124 that allows the device 102 to receive incoming datagrams from the external network 108.

If the STUN client 102A successfully obtains a routable IP address and associated port for receiving datagrams, one or more devices of the external network 108 (as represented by the service consumer 128) can send a datagram to the device 102 by using the address/port combination in the destination field 130 of an IP header. The client 102A can make this accessible address/port 130 known to the discovery server 126. For example, the client 102A may publish this address by sending a PAOS GET to the server 126 to establish the address/port 130 for use by a SOAP requester such as the service consumer 128. In another example, the STUN client 102 can send a Liberty ID-WSF Discovery Update message to an ID-WSF discovery service (DS) (e.g., the server 126), and publishing a ResourceOffering with that DS 126. The ResourceOffering describes the network “endpoint” that offers the service, which includes the address and port 130 that can be accessed by the SOAP requester 128.

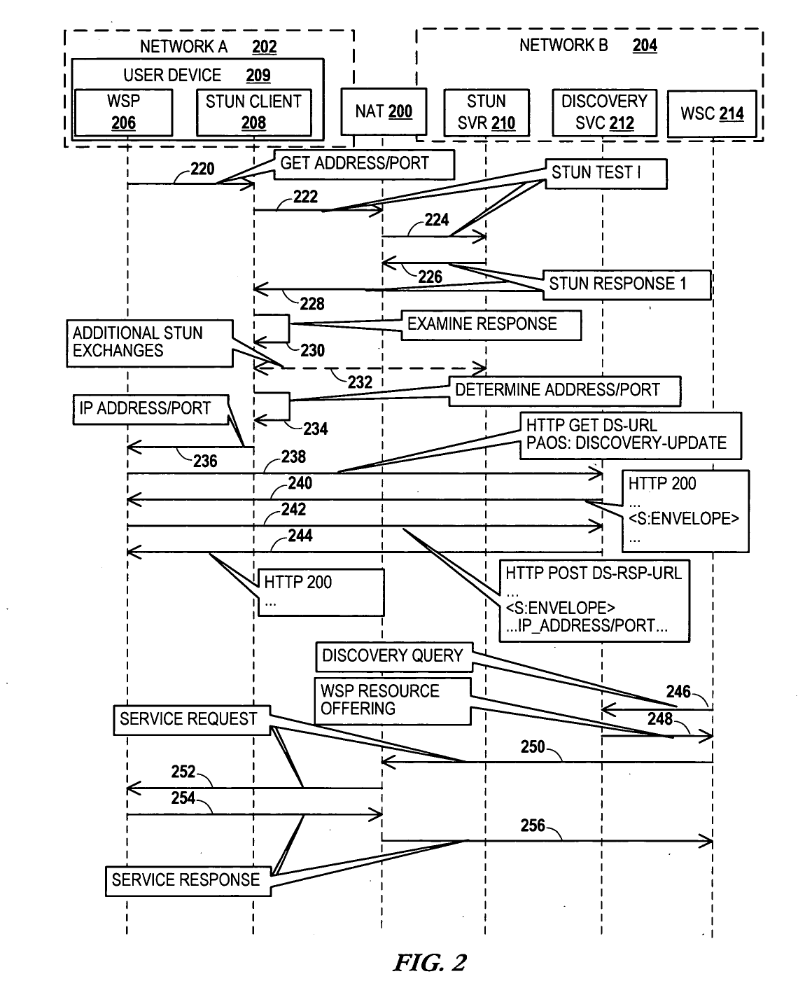

A more particular example of service discovery for a NAT firewalled device according to an embodiment of invention is shown in the sequence diagram of FIG. 2. Generally, a NAT 200 resides on the edge of a first network 202 and has an external, routable interface on a second network 204. A web service provider (WSP) 206 and STUN client 208 operate on a device 209 of the first network 202 and access the second network 204 via the NAT 200. The WSP 206 may communicate with the STUN client 208 via interprocess communications or other communication means provided on the device 209.

Typically, the WSP 206 and STUN client 208 are functional modules residing on the same device 209. However it is possible that they are separate network devices. In that case the entities 206, 208 may use network remote procedure calls (e.g., SOAP, XML-RPC, Java RMI). If the WSP 206 and STUN client 208 are separate network entities, then the STUN client 208 would also be acting as a proxy for the WSP 206, at least as far as incoming traffic from the second network 204. This is because the STUN client 208 will obtain a routable address for its own network interface, and thus would have to forward any traffic received via that interface to the end user, e.g., the WSP 206.

The user device 209 running the WSP 206 may learn of the existence of the first network 202 as soon as the device 209 powers up or when a network connection is requested, either manually or automatically. The device 209 may also know of the existence of the second network 204, insofar as the device 209 has been provided the IP address of a default gateway, e.g., the address of the NAT 200 on the first network 202. The device 209 can assume that, if an outgoing connection request includes a destination IP address that is not on the local network 202, the request can be sent via the NAT gateway 200, which will route the request to the second network 204. A STUN server 210, discovery service 212, and a Web Service Client (WSC) 214 reside on the second network 204. These entities 210, 212, 214 may reside on the same or different devices. The second network 204 may include a plurality of networks, as is the case if the second network 204 is the Internet.

Although the device 209 may assume that the NAT 200 can route traffic to other networks, the device 209 cannot yet determine that the NAT 200 is anything but a router/gateway. Therefore, if the device 209 wishes to ensure that connections requests may be received at the WSP 206 directly from the second network 204, the WSP 206 may make a procedure call 220 (e.g., via an API) to the STUN client 208 to obtain a globally routable IP address and port for receiving UDP packets. Note that this address will be different than the local IP address of the device 209, unless the device 209 is already coupled directly to the second network 204.

In response to the IP address request 220, the STUN client 208 sends a STUN message 222 to the STUN server 210. The STUN message 222 is first received by the NAT 200 and the UDP/IP headers are changed by the NAT 200 before forwarding 224 the message. The STUN message 222, 224 is a specially crafted UDP datagram that instructs the STUN server 210 to respond 226, 228 with details obtained from the UDP/IP headers. The STUN client 208 examines 230 the response 228 to determine what further processing. Depending on the response 228, the STUN client 208 and server 210 may engage in additional message exchanges 232, after which the STUN client 208 can determine 234 whether the client 208 is behind a NAT 200, and if so, whether the NAT 200 has mapped an IP address and port for receiving incoming UDP requests.

Assuming that the STUN client 208 has determined 234 a routable IP address and open port accessible via the NAT 200, this address/port be passed 236 to the requester, the WSP 206. Thereafter, the WSP 206 can use this address and port to accept discovery requests. In this example, the WSP 206 utilizes PAOS to communicate this ability to the discovery service 212. The PAOS transaction begins with an HTTP GET 238 to the discovery service, the GET including a PAOS header entry describing that this is for the purposes of updating discovery information for the WSP 206. The discovery service 212 sends a response 240 that includes a SOAP message with the update request. The WSP 206 then responds 242 initiating an HTTP POST containing the IP address/port (among any other information contained in the request 240) and the service 212 responds 244 indicating success.

After the WSP 206 has obtained and advertised its services with the discovery service 212, the WSC 214 can discover the service via a query 246 and response 248. Once the service is discovered, the WSC 214 can access 250, 252, 254, 256 the services of WSP 206 through the NAT 200. Generally, these initial requests 250, 252 may be in the form of one or more UDP datagrams sent to the open address/port being mapped to the WSP 206 by the NAT 200. Thereafter, the transactions (e.g., responses 254, 256) may continue to use UDP as the underlying transport protocol. Alternatively, some other mechanism such as PAOS may be used to provide the service from the WSP 206 to the WSC 214.

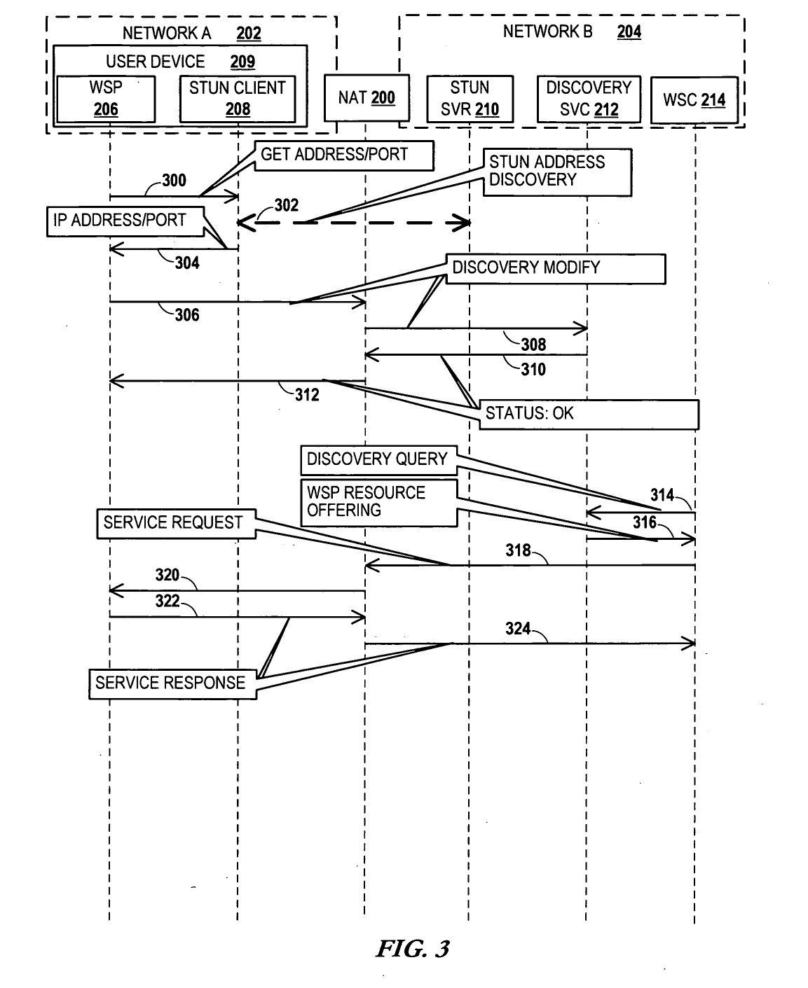

An alternate discovery update scenario according to an embodiment of the invention is illustrated in FIG. 3. FIG. 3 uses the same reference numerals to denote corresponding functional elements as shown in FIG. 2, and the descriptions thereof will be omitted. As in FIG. 3, the WSP 206 requests 300 a publicly routable address and port from the STUN client 208. The STUN client 208 interacts with the STUN server 210 using message exchanges 302 such as described in FIG. 2, the details of which are omitted here. Assuming the STUN client 208 obtains an IP address and port, this data is transmitted 304 to the WSP 206.

Once the WSP 206 has identified a publicly routable address and port via the STUN client 208, the WSP 206 publishes this address using the standard Liberty ID-WSF discovery update procedure. This involves sending a discovery Modify message 306, 308 to the discovery service 212. If successful, the discovery service 212 responds 310, 312 with an acknowledgement of a successful update. Thereafter, the WSC 214 can discover 314, 316 and utilize 318, 320, 322, 324 the service as described in relation to FIG. 2.

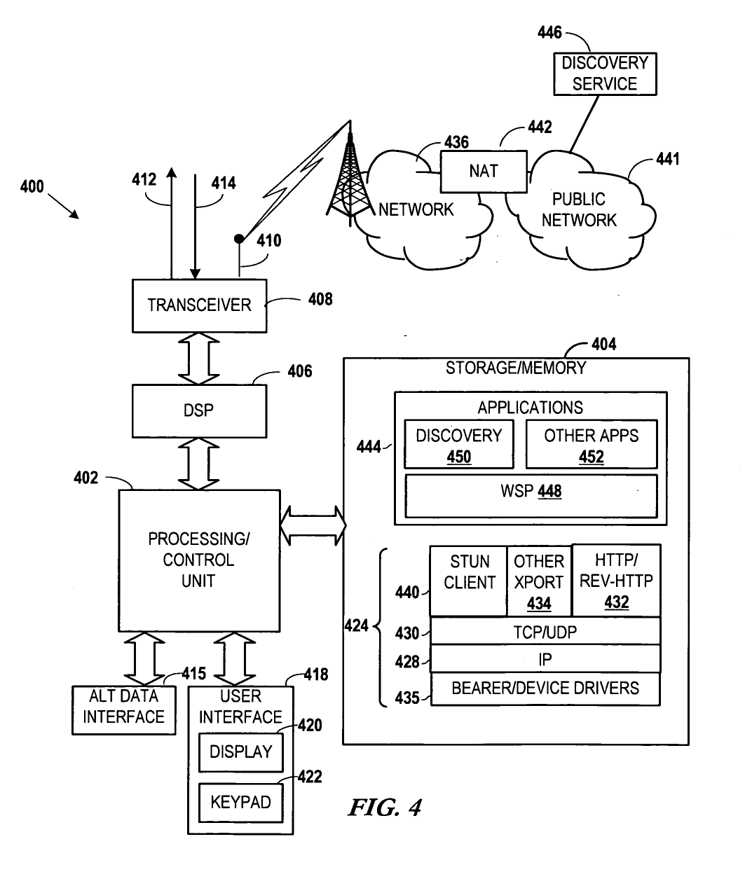

Many types of apparatus may be able provide services behind NATs or in similarly restricted network environments. Mobile devices are particularly useful in this role. In reference now to FIG. 4, an example is illustrated of a representative mobile computing arrangement 400 capable of carrying out operations in accordance with embodiments of the invention. Those skilled in the art will appreciate that the exemplary mobile computing arrangement 400 is merely representative of general functions that may be associated with such mobile devices, and also that landline computing systems similarly include computing circuitry to perform such operations.

The processing unit 402 controls the basic functions of the arrangement 400. Those functions associated may be included as instructions stored in a program storage/memory 404. In one embodiment of the invention, the program modules associated with the storage/memory 404 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 400 via data signals, such as being downloaded electronically via one or more networks, such as the Internet and an intermediate wireless network(s).

The mobile computing arrangement 400 includes hardware and software components coupled to the processing/control unit 402 for performing network data exchanges. The mobile computing arrangement 400 may include multiple network interfaces for maintaining any combination of wired or wireless data connections. In particular, the illustrated mobile computing arrangement 400 includes wireless data transmission circuitry for performing network data exchanges with at least a local network 436.

This wireless circuitry includes a digital signal processor (DSP) 406 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 408, generally coupled to an antenna 410, transmits the outgoing radio signals 412 and receives the incoming radio signals 414 associated with the wireless device. The mobile computing arrangement 400 may also include an alternate network/data interface 415 such as USB, Bluetooth, Ethernet, 802.11 Wi-Fi, IRDA, etc.

The processor 402 is also coupled to user-interface elements 418 associated with the mobile terminal. The user-interface 418 of the mobile terminal may include, for example, a display 420 such as a liquid crystal display. Other user-interface mechanisms may be included in the interface 418, such as keypads 422, speakers, microphones, voice commands, switches, touch pad/screen, graphical user interface using a pointing device, trackball, joystick, etc. These and other user-interface components are coupled to the processor 402 as is known in the art.

The program storage/memory 404 typically includes operating systems for carrying out functions and applications associated with functions on the mobile computing arrangement 400. The program storage 404 may include one or more of read-only memory (ROM), flash ROM, programmable and/or erasable ROM, random access memory (RAM), subscriber interface module (SIM), wireless interface module (WIM), smart card, hard drive, or other removable memory device. The storage/memory 404 of the mobile computing arrangement 400 may also include software modules for performing functions according to embodiments of the present invention.

In particular, the program storage/memory 404 may include one or more network processing stacks 424. The processing stack 424 contains processing layers associated with conventional Internet communications. Among these processor layers are standard network protocols, such as IP 428, TCP/UDP 430, HTTP/reverse-HTTP 432, and other application-layer transport protocols 434. Generally, the lower layers of the processing stack interface with network hardware and data bearers through low-level routines/drivers 435. These drivers 428 provide a software interface for controlling data communications hardware such as the DSP 406, transceiver 406, and alternate data interface 415. It will be appreciated that the layers of the processing stack 424 need not be separate entities, and may share common functions/libraries.

Other elements of the processing stack 424 include a STUN client module 440. The STUN client module 440 provides the ability to determine whether the arrangement 400 has access to a public network 441 via a NAT 442, and if so, what public addresses and ports may be open for receiving data. The STUN client 440 may include an API accessible by applications 444 of the data processing arrangement 400. These applications 444 may include a WSP 448 for providing particular network services. A discovery client 450 is capable of interacting with a discovery service 446 located on the public network 441 for purposes of advertising the services of the WSP 448 or other applications 452. The discovery client 450, WSP 448, and other applications 452 may interact with the STUN client 440 in order to determine a public address of the arrangement 400. The discovery client 450 can communicate this public address to the discovery service 446, thereby allowing entities of the public network 441 to access the arrangement 400 via the NAT 442 in order to utilize the services of the WSP 448.

The mobile computing arrangement 400 of FIG. 4 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

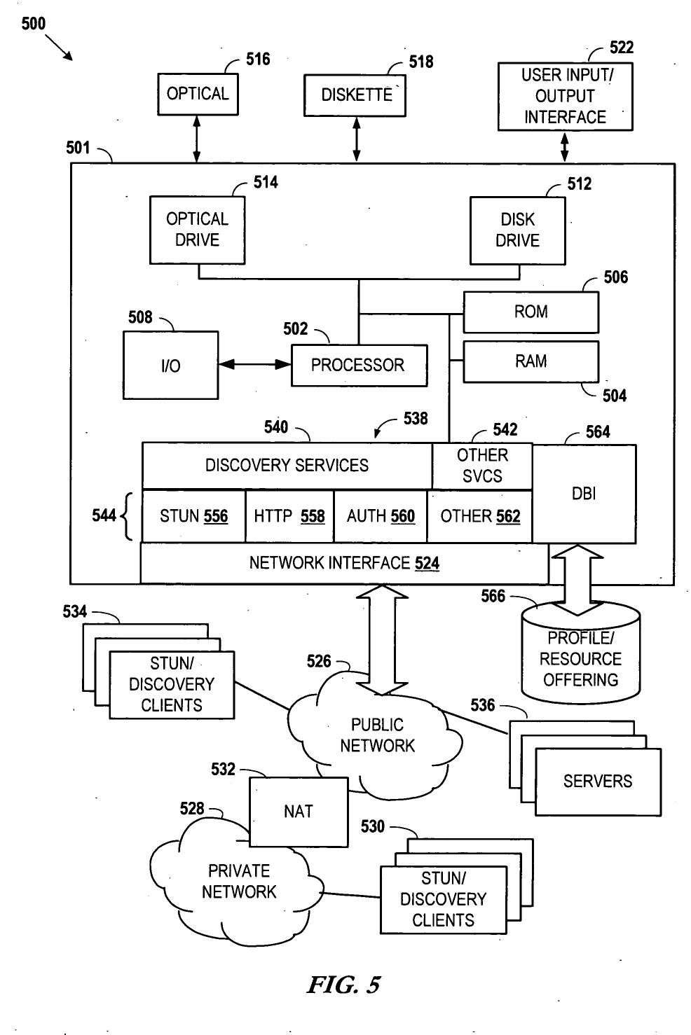

The STUN protocol relies upon one or more network entities (e.g., STUN servers) that are made available on public networks so that STUN clients may test for the existence of NATs between the clients and the public networks. In addition, this STUN server functionality may be combined with other network functions such as discovery service. These functions may be provided by computing arrangements distributed across multiple communications networks. An example apparatus that may carry out a combination of these functions is shown in FIG. 5.

FIG. 5 shows an example computing structure 500 suitable for providing services according to embodiments of the present invention. The computing structure 500 includes a computing arrangement 501. The computing arrangement 501 may include custom or general-purpose electronic components. The computing arrangement 501 includes a central processor (CPU) 502 that may be coupled to random access memory (RAM) 504 and/or read-only memory (ROM) 506. The ROM 506 may include various types of storage media, such as programmable ROM (PROM), erasable PROM (EPROM), etc. The processor 502 may communicate with other internal and external components through input/output (I/O) circuitry 508. The processor 502 carries out a variety of functions as is known in the art, as dictated by software and/or firmware instructions.

The computing arrangement 501 may include one or more data storage devices, including hard and floppy disk drives 512, optical drives 514, and other hardware capable of reading and/or storing information such as flash memory, holographic memory, etc. In one embodiment, software for carrying out the operations in accordance with the present invention may be stored and distributed on an optical media 516, diskette 518 or other form of media capable of portably storing information. These storage media may be inserted into, and read by, devices such as the optical drive 514, the disk drive 512, etc. The software may also be transmitted to computing arrangement 501 via data signals, such as being downloaded electronically via a network, such as the Internet. The computing arrangement 501 may be coupled to a user input/output interface 522 for user interaction. The user input/output interface 522 may include apparatus such as a mouse, keyboard, microphone, touch pad, touch screen, voice-recognition system, monitor, LED display, LCD display, etc.

The computing arrangement 501 may be coupled to other computing devices via networks. In particular, the computing arrangement includes one or more network interfaces 524 for interacting with at least public networks 526. The network interface 524 may have assigned to it two or more unique IP addresses of the public networks to facilitate STUN requests sent by one or more clients 530 of a private network 528. The private network 528 may be coupled to the public networks 526 by one or more NATs 532. The network interface 524 may also accept STUN requests (as well as performing any other transaction) with clients 534 directly connected to the public networks 526.

The network interface 524 may include a combination of hardware and software components, including media access circuitry, drivers, programs, and protocol modules. Ultimately, the computing arrangement 501 may facilitate session interactions between clients 530, 534 and other entities such as servers 536 for purposes of sharing network services between devices, particularly those devices that are located behind a NAT 532. The service interactions between entities 530, 534, 536 may take place on a single network (e.g., network 526) or across two or more networks 526, 528.

The computing arrangement 501 includes processor executable instructions 538 for carrying out tasks of the computing arrangement 501. These instructions may include a discovery services module 540 capable of providing network services identification such defined in the Liberty ID-WSF DS. The arrangement 501 may also include other service modules 542 for providing services such as ID-WSF Interaction services, personal profile services, security, etc. The instructions 538 also include a protocol layer 544 that may include underlying network protocols as STUN 556, HTTP 558, authentication 560, and other core network services/protocols 562. The components of the protocol layer 544 may be configured with client and server behavior where appropriate.

The various functional modules 538 may require accessing persistent data. For example, a database interface 564 may provide a common data storage and retrieval for functional modules such as discovery services 540. The database interface 564 allows access to local or remote databases 566, that may be used to store such data as user profiles and ID-WSF resource offerings. The database 566 may be accessible via any combination of local I/O busses 508 and network interfaces 524.

The computing structure 500 is only a representative example of network infrastructure hardware that can be used to provide services as described herein. Generally, the functions of the computing structure 500 can be distributed over a large number of processing and network elements, and can be integrated with other services, such as service enablers, gateways, mobile communications messaging, etc.

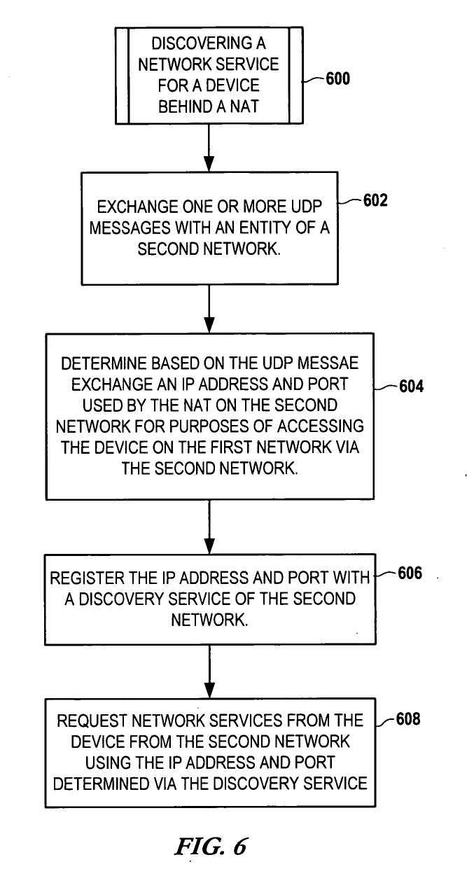

In reference now to FIG. 6, a flowchart illustrates a procedure 600 for discovering a network service. This procedure generally pertains to a device capable of operating on a first network that is coupled to a second network via a Network Address Translator (NAT). One or more UDP messages are exchanged 602 with an entity of the second network. Typically, the UDP message exchange is based on the STUN protocol, although other UPD based protocols may be used. Based on the exchange 602 of UDP messages, an IP address and port used by the NAT on the second network is determined 604 for purposes of accessing the device on the first network via the second network. The IP address and port are registered 606 with a discovery service of the second network. Devices on the second network can determine the IP address and port from the discovery service, and request 608 network services from the device via the second network using the IP address and port. As long as the NAT maintains a mapping of the IP address and port to the device's address on the first network, requesters can repeatedly and asynchronously request network services from the device, including identity services in compliance with ID-WSF.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method for discovering a network service on a device capable of operating on a first network that is coupled to a second network via a Network Address Translator (NAT), comprising:
exchanging one or more User Datagram Protocol (UDP) messages with an entity of the second network;
determining, based on the exchange of UDP messages, an IP address and port used by the NAT on the second network for purposes of accessing the device on the first network via the second network;
registering the IP address and port with a discovery service of the second network; and
requesting network services from the device via the second network using the IP address and port obtained via the discovery service.

2. The method of claim 1, wherein exchanging the one or more UDP messages with the entity of the second network comprises exchanging Simple Traversal of UDP Through NATs (STUN) messages with a STUN server of the second network.

3. The method of claim 1, wherein the registering the IP address and port with the discovery service comprises registering using a Reverse Hypertext Transport Protocol Binding for SOAP (PAOS) procedure call.

4. The method of claim 1, wherein the registering the IP address and port with the discovery service comprises registering using a Liberty Foundation Web Services Framework (ID-WSF) discovery Modify message.

5. The method of claim 1, wherein requesting network services from the device via the second network using the IP address and port comprises asynchronously sending a UDP datagram to the IP address and port via the second network.

6. The method of claim 5, further comprising providing the network service from the device in response to the UDP datagram.

7. The method of claim 6, wherein providing the network service comprises providing the service via Reverse Hypertext Transport Protocol Binding for SOAP (PAOS).

8. The method of claim 6, wherein providing the network service comprises providing the service via an exchange of additional UDP datagrams.

9. The method of claim 1, wherein registering the IP address and port with the discovery service of the second network registering comprises communicating to the discovery service a reference to one or more ID-WSF resource offerings of the device.

10. A data processing arrangement comprising:
a network interface capable of communicating via a local network using a local address;
a processor coupled to the network interface; and
a memory coupled to the processor, the memory including instructions that cause the processor to,
initiate a User Datagram Protocol (UDP) message exchange with a server of a public network;
determine, based on the UDP message exchange, an address and port of the public network usable to access the data processing arrangement on the local network via the public network;
register the IP address and port with a discovery service of the public network; and
receive network service requests from entities of the public network that obtained the IP address and port via the discovery service.

11. The data processing arrangement of claim 10, wherein the UDP messages comprise Simple Traversal of UDP Through NATs (STUN) messages.

12. The data processing arrangement of claim 10, wherein the memory causes the processor to register the IP address and port with the discovery service using a Reverse Hypertext Transport Protocol Binding for SOAP (PAOS) procedure call.

13. The data processing arrangement of claim 10, wherein the memory causes the processor to register the IP address and port with the discovery service using a Liberty Foundation Web Services Framework (ID-WSF) Discovery Modify message.

14. The data processing arrangement of claim 10, wherein the memory further causes the processor to asynchronously receive a UDP datagram via the IP address and port of the public network, and wherein the network service is provided in response to the UPP datagram.

15. The data processing arrangement of claim 14, wherein the memory causes the processor to provide the service using Reverse Hypertext Transport Protocol Binding for SOAP (PAOS).

16. The data processing arrangement of claim 10, wherein the memory causes the processor to register the IP address and port with the discovery service of the second network by communicating to the discovery service a reference to one or more Foundation Web Services Framework (ID-WSF) resource offerings of the device.

17. A system comprising:
a first and second network coupled via a Network Address Translator (NAT);
a data processing device capable of operating on the first network;
means for determining an IP address and port used by the NAT on the second network for purposes of accessing the device on the first network via the second network;
means for registering the IP address and port with a discovery service of the second network; and
means for requesting network services from the device via the second network.

18. A server comprising:
a network interface capable of communicating via a public network;
a processor coupled to the network interface; and
a memory coupled to the processor, the memory including instructions that cause the processor to,
exchange via the network interface Simple Traversal of User Datagram Protocol Through Network Address Translators (STUN) messages with a mobile device coupled to the public network via a Network Address Translator (NAT), the STUN message exchange used to determine an address and port of the NAT usable for accessing the mobile device via the public network;
receive via the network interface a registration request associating the IP address and port with a network service of the mobile device; and
provide via the network interface a descriptor of the network service containing the IP address and port in response to a service query received via the public network.

19. The server of claim 18, wherein the service query comprises a Liberty Foundation Web Services Framework (ID-WSF) Discovery Query.

20. A processor readable medium having instructions stored thereon which are executable by a data processing arrangement capable of being coupled to a local network for performing steps comprising:
exchanging one or more User Datagram Protocol (UDP) messages with an entity of a public network via the local network, the public network coupled to the local network via a Network Address Translator (NAT);
determining, based on the exchange of UDP messages, an IP address and port of the public network used by the NAT for purposes of accessing the data processing arrangement on the local network via the public network;
registering the IP address and port with a discovery service of the public network; and
receiving network service requests via the IP address and port of the public network that were obtained via the discovery service.

21. The processor readable medium of claim 20, wherein exchanging the one or more UDP messages with the entity of the second network comprises exchanging Simple Traversal of User Datagram Protocol Through NATs (STUN) messages with a STUN server of the second network.

22. The processor readable medium of claim 20, wherein the registering the IP address and port with the discovery service comprises registering using a Reverse Hypertext Transport Protocol Binding for SOAP (PAOS) procedure call.

23. The processor readable medium of claim 20, wherein the registering the IP address and port with the discovery service comprises registering using a Liberty Foundation Web Services Framework (ID-WSF) discovery Modify message.

24. The processor readable medium of claim 20, wherein requesting network services from the device via the second network using the IP address and port comprises asynchronously sending a UDP datagram to the IP address and port via the second network.

25. The processor readable medium of claim 24, wherein the steps further comprise providing the network service from the device in response to the UDP datagram.

26. The processor readable medium of claim 25, wherein providing the network service comprises providing the service via Reverse Hypertext Transport Protocol Binding for SOAP (PAOS).

27. The processor readable medium of claim 25, wherein providing the network service comprises providing the service via an exchange of additional UDP datagrams.

28. The processor readable medium of claim 20, wherein registering the IP address and port with the discovery service of the second network registering comprises communicating to the discovery service a reference to one or more ID-WSF resource offerings of the device.
